(19) United States
(12) Patent Application Publication
(10) Pub. No.: US 2014/0034804 A1
(43) Pub. Date: Feb. 6, 2014

(54) DOWN SPRUE CORE FOR USE IN CASTING RAILCAR COUPLER KNUCKLES

(71) Applicant: Bedloe Industries LLC, Wilmington, DE (US)

(72) Inventors: F. Andrew Nibouar, Chicago, IL (US); Jerry R. Smerecky, Roselle, IL (US); Kelly Day, Sparta, MI (US); Nick Salamasick, Nunica, MI (US); Vaughn Makary, Muskegon, MI (US); Roy Stevenson, Elgin, IL (US)

(73) Assignee: Bedloe Industries LLC, Wilmington, DE (US)

(21) Appl. No.: 14/048,160

(22) Filed: Oct. 8, 2013

Related U.S. Application Data
(62) Division of application No. 13/194,601, filed on Jul. 29, 2011, now abandoned.

(51) Int. Cl. B29C 33/76

(52) U.S. Cl. CPC B29C 33/76
USPC 249/177

(57) ABSTRACT

A core for use in railcar coupler part casting processes is provided. The core includes a body with a side wall, a first opening in a top wall of said body a second opening in a bottom wall of said body, a channel defined through said body connecting said first and said second openings, and at least one channel defined in said bottom wall.

### FIELD OF INVENTION

The present invention relates generally to the field of methods and apparatuses for casting railcar coupler knuckles. The present invention relates specifically to a down sprue core and related construction for casting railcar coupler parts.

### BACKGROUND

Railcar couplers are disposed at each end of a railway car to enable joining one end of such railway car to an adjacently disposed end of another railway car. The engagable portions of each of these couplers are known in the railway art as knuckles. For example, railway freight car coupler knuckles are taught in U.S. Pat. Nos. 4,024,958; 4,206,849; 4,605,133; and 5,582,307.

Coupler knuckles are generally manufactured from a cast steel using a mold and three cores that produce the interior spaces of the knuckles. These three cores typically make up the rear core or “kidney” section, the middle core or “C-10” or “pivot pin” section, and the front core or “finger” section. During the casting process itself the interrelationship of the mold and three cores disposed within the mold is critical to producing a satisfactory railway freight car coupler knuckle.

The most common technique for producing these components is through sand casting. Sand casting offers a low cost, high production method for forming complex hollow shapes such as coupler bodies, knuckles, side frames and bolsters. In a typical sand casting operation, (1) a mold is formed by packing sand around a pattern, which generally includes the gating or rigging system; (2) The pattern is removed from the mold; (3) cores are placed into the mold, which is closed; (4) the mold is filled with hot liquid metal through the gating; (5) the metal is allowed to cool in the mold; (6) the solidified metal, referred to as raw casting, is removed by breaking away the mold; (7) and the casting is finished and cleaned which may include the use of grinders, welders, heat treatment, and machining.

In the various casting techniques, different sand binders are used to allow the sand to retain the pattern shape. These binders have a large effect on the final product, as they control the dimensional stability, surface finish, and casting detail achievable in each specific process. Two sand casting methods include (1) green sand, consisting of silica sand, clay, organic binders and water; and (2) no-bake or air set consisting of silica sand and fast curing chemical adhesives. Traditionally, coupler bodies and knuckles have been created using the green sand process, due to the lower cost associated with the molding materials. While this method has been effective at producing these components for many years, there are disadvantages to this process.

In a sand casting operation, the mold is created using sand as a base material, mixed with a binder to retain the shape. The mold is created in two halves—cope (top) and drag (bottom) which are separated along the parting line. The sand is packed around the pattern and retains the shape of the pattern after it is extracted from the mold. Draft angles are machined into the pattern to ensure the pattern releases from the mold during extraction. In some sand casting operations, a flask is used to support the sand during the molding process through the pouring process. Cores are inserted into the mold and the cope is placed on the drag to close the mold.

When casting a complex or hollow part, cores are used to define the hollow interior, or complex sections that cannot otherwise be created with the pattern. These cores are typically created by mixing sand and binder together and then filling a box shaped as the feature being created with the core. These core boxes are either manually packed or created using a core blower. The cores are removed from the box, and placed into the mold. The cores are located in the mold using core prints to guide the placement, and prevent the core from shifting while the metal is poured. Additionally, chaplets may be used to support or restrain the movement of cores, and fuse into the base metal during solidification.

The mold typically contains the gating or “rigging” system which provides a path for the molten metal, and allows metal to flow into the cavities that make up the shape of the part being cast. This gating typically consists of a down sprue that feeds into a well which in turn connects to runners. The runners are channels defined in the cope and/or drag sections of the mold for metal to flow through. Runners typically connect to risers, which act as reservoirs for extra molten metal to continue to feed the part cavities as the metal cools. Ingates exit the risers and/or runners and feed into the mold cavities to allow metal to flow into the mold cavities to create the part.

After the metal has been poured into the mold, the casting cools and shrinks as it approaches a solid state. As the metal cools and solidifies, additional liquid metal must continue to feed the areas that contract, or voids will be present in the final part. In locations with heavy thick metal sections, risers are placed in the mold to provide a secondary reservoir of liquid metal. These risers are the last areas to solidify, and thereby allow the contents to remain in the liquid state longer than the cavities. As the contents of the cavities cools, the risers feed the areas of contraction, ensuring a solid final casting is produced. Risers that are open on the top of the cope mold can also act as vents for gases to escape during pouring and cooling.

The proper design and placement of ingates in a gating system are critical factors that can help to reduce and eliminate the amount of harmful inclusions that can form during the filling of the gating system and mold cavity. If the ingates and gating system are not properly sized, or placed in locations on the casting that cause the melt front to fall unnecessarily, a turbulent melt flow will occur which will cause the liquid metal to entrain pockets of air which will cause inclusions, often times referred to as reoxidation inclusions, to form. These inclusions can have negative effects on the part quality and potentially compromise the service performance of the casting. Additionally, such inclusions will often times require costly secondary manufacturing processes to identify, remove, and repair inclusions located in undesirable locations.

In addition to reoxidation inclusions, a turbulent melt front can also increase the total gas content of the liquid metal, which can lead to gas porosity defects that appear in the last places to solidify as the gas solubility levels in these areas are exceeded during solidification.

Other common sources of inclusions in steel castings typically consist of eroded molding sand, entrained slag from the furnace or ladle, and entrained refractory material from the melt furnace or ladle. All of these inclusion types can either be caused or further exacerbated by a poorly designed gating system or a turbulent filling pattern.

Another consideration when placing ingates during the design of the gating system is the potential damage that can be done locally during the riser and ingate removal processes. Imperfections created in the surface finish during these operations can have detrimental effects on the performance and service life of a casting in some instances. Therefore it becomes very important that areas which are known to be critical to the part's performance or sensitive to such imperfections are kept free of features such as ingates, riser contacts, and chills that will cause secondary processing to become necessary in those areas. Due to the non-symmetrical shape of railcar coupler knuckles and their varying wall thicknesses, functional limitations dictate the positioning of the ingates in positions that are not tolerant of imperfections, such as the throat and pulling faces.

In a traditional casting process, metal is poured into the down sprue and runs into a well formed directly in the mold. The molten metal flows through the runners from the well into the risers and ingates which feed the metal into the mold cavities. Some casting methods cast more than one knuckle at a time in one mold. Traditionally in these systems, each riser has multiple ingates exiting therefrom. Each ingate feeds one knuckle cavity. Depending on the number of knuckle cavities in the mold, the well can also feed multiple risers through multiple runners.

Many knuckles fail from the internal inconsistencies described above and/or external surface inconsistencies in the metal through the knuckle. These inconsistencies can result in offset loading and increased failure risk during use of the knuckle.

### SUMMARY OF INVENTION

In a first embodiment, a core for use in railcar coupler part casting processes, has a hollow body, a top with a first opening defined therein, a bottom having a generally rounded wall, and second and third openings defined in the side wall of the body.

In a second embodiment, a core for use in railcar coupler part casting processes has a hollow body, a top with a first opening defined therein, a bottom wall and a plurality of openings defined in a side wall of the body.

In a third embodiment, a core for use in railcar coupler part casting processes, has a hollow body, a top wall with a first opening defined therein, a bottom having a wall, and at least one opening defined in a side wall

In a fourth embodiment, a core for use in railcar coupler part casting processes, includes a body with a side wall, a first opening in a top wall of said body a second opening in a bottom wall of said body, a channel defined through said body connecting said first and said second openings, and at least one channel defined in said bottom wall.

In a fifth embodiment, a core construction for use in casting railcar coupler parts, includes a core with a body, a first opening in a top wall of said body, a second opening in a bottom wall of said body, a channel defined through said body connecting said first and said second openings, at least one channel defined in said bottom wall, at least one filter seat defined in said bottom wall, and at least one filter positioned in said filter

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like-referenced numerals designate corresponding parts throughout the different views.

FIG. 1 shows a perspective view of an embodiment of the rigging and four complete cast knuckles;

FIG. 2 shows a perspective view of the rigging of FIG. 1 with one knuckle removed to show an ingate;

FIG. 3 shows a side view of the rigging of FIG. 1 with two knuckles removed and examples of possible measurements shown;

FIG. 4 shows a top view of the rigging of FIG. 1;

FIG. 5 shows a top view of the rigging of FIG. 1 showing examples of the outer dimensions of the rigging;

FIG. 6 shows a top view of a riser from FIG. 1;

FIG. 7 shows a side view of a riser from FIG. 1 with the knuckle removed;

FIG. 8 shows a side view of an ingate from FIG. 7;

FIG. 9 shows a side view of an ingate from FIG. 7;

FIG. 10 shows a side view of a runner from FIG. 1;

FIG. 11 shows a side view of the well, runner and riser from FIG. 1;

FIG. 12 shows a perspective view of the drag portion of a mold with an embodiment of a down sprue core in place;

FIG. 13 shows a perspective view of FIG. 12 with the down sprue core out of the mold;

FIG. 14 shows a side view of the down sprue core of FIG. 12;

FIG. 15 shows a side view of the down sprue core of FIG. 12

FIG. 16 shows a bottom view of the down sprue core of FIG. 12;

FIG. 17 shows a perspective view of the down sprue core of FIG. 12;

FIG. 18 shows a perspective view of a second embodiment of a down sprue core;

FIG. 19 is an exploded view of the core of FIG. 18;

FIG. 20 is an exploded view of the core of FIG. 18;

FIG. 21 is a perspective view of one half of the core of FIG. 18;

FIG. 22 is a perspective view of one half of the core of FIG. 18;

FIG. 23 is a perspective view of a drag with the core of FIG. 18 in position;

FIG. 24 is a perspective view of a third embodiment of a down sprue core;

FIG. 25 is a perspective view of the core of FIG. 24 with filters in place;

FIG. 26 is a bottom plan view of the core of FIG. 24;

FIG. 27 is a side cross-sectional view of the core of FIG. 24;

FIG. 28 is an exploded view of the down sprue core of FIG. 24 showing the cope and drag portions, the knuckle cores and the filters;

FIG. 29 is a side view of the system of FIG. 28;

FIG. 30 is a perspective view of the drag of FIG. 28;

FIG. 31 is a perspective view of the drag of FIG. 30 with the filters about to be placed in position in the drag;

FIG. 32 is a perspective view of the drag of FIG. 30 showing the down sprue core of FIG. 24 and the knuckle cores about to be placed in position in the drag;

FIG. 33 is a perspective view of the drag of the system of FIG. 32 with the down sprue core and knuckle cores seated in the drag with the cope about to be placed in position on the drag;

FIG. 34 is a perspective view of the closed cope and drag of FIG. 33 with the cope shown in phantom in order to see the internal features and parts in place in the drag;

FIG. 35 is a top view of the mold showing line C-C;

FIG. 36 is a side cross-sectional view along line C-C of FIG. 35;

FIG. 37 is a top view of a set of knuckles and rigging as cast;

FIG. 38 is a top perspective view of the cast knuckles and rigging of FIG. 37;

FIG. 39 is a bottom view of the cast knuckles and rigging of FIG. 37;

FIG. 40 is a bottom perspective view of the cast knuckles and rigging of FIG. 37;

FIG. 41 is a top view of the cast knuckles and rigging of FIG. 37 showing line B-B;

FIG. 42 is a side cross-sectional view along line B-B of FIG. 41;

FIG. 43 is a perspective view of the of one riser from the rigging of FIG. 37 showing two cast knuckles and the down sprue core of FIG. 24 shown in phantom and the down sprue shown in phantom;

FIG. 44 is a side view of the rigging portion shown in FIG. 43; and

FIG. 45 is a perspective view of the rigging portion shown in FIG. 43.

### DETAILED DESCRIPTION OF THE DRAWINGS AND THE PRESENTLY PREFERRED EMBODIMENTS

The disclosure herein describes a rigging system (also known as a gating system) for casting railcar coupler knuckles as well as a core for use with the rigging. Referring to the Figures, in one embodiment, coupler knuckles 10 are formed from cope (upper) (not shown) and drag (lower) 14 portions of a mold. The cope and drag 14 portions may be formed from “green sand” in a flask (not shown). In such a process, a coupler knuckle pattern is placed in a flask, green sand (a mixture of silica sand, clay, organic binders and water is poured over it, packed tightly and then heated to set the molds. The patterns are removed, leaving cavities 16 that form the outer walls of the coupler knuckle 10. In this process, the flasks remain in place around the sand molds during the metal pouring process in order to maintain the shape of the molds.

In an alternative process, the cope 12 and drag 14 portions are formed using an “air-set” process wherein molding sand mixed with binders such as phenolic urethane is used in place of the green sand. In this process, it is not necessary to bake the sand in order to set it. Furthermore, air-set or no-bake molds can be removed from the flasks after setting and used to cast the parts in a “flaskless” process.

The cope 12 and drag 14 portions each include one or more knuckle cavities 16 that form the shape of the outside surface of the coupler knuckle or knuckles. The knuckle cavities 16 are typically formed with half the cavity 16 in the cope 12 and half in the drag 16. The embodiment illustrated in the figures shows drag 14 portions with four knuckle cavities formed therein to allow casting of four knuckles simultaneously. In addition to the knuckle cavities 16, the cope portion includes a down sprue 18 that feeds into a well 20 as shown in FIG. 13. In the illustrated embodiment, a down sprue core 51, multiple embodiments of which will be described later, fits in the well 20 to provide an additional pathway for the molten metal without problematic erosion of the sand making up the well 20. The well 20 or down sprue core 51 in turn includes runners 22 that feed into risers 24 that in turn include ingates 26 exiting the side walls 28 of the risers 24 and feed into the knuckle cavities 16.

In the casting process, cores 146 that form the internal spaces of the coupler knuckles are placed in the knuckle cavities and the cope and drag 14 portions are closed together. Molten metal is poured into the down sprue 18 and flows down the down sprue 18 into the well 20 or the down sprue core 51. The molten metal travels out of the well 20 or down sprue core 51, through the runners 22, into the risers 24 and through the ingates 26 into the knuckle cavities 16. The cast knuckles 10 are allowed to cool before the mold is removed.

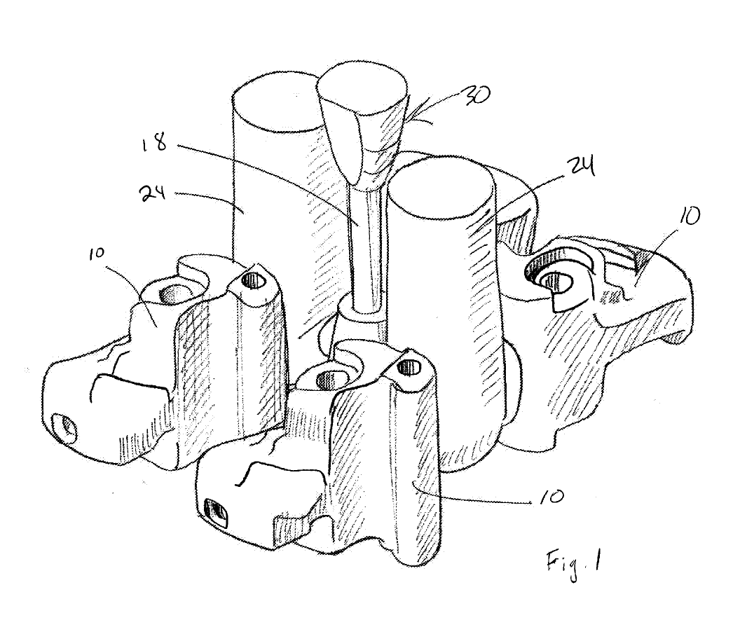

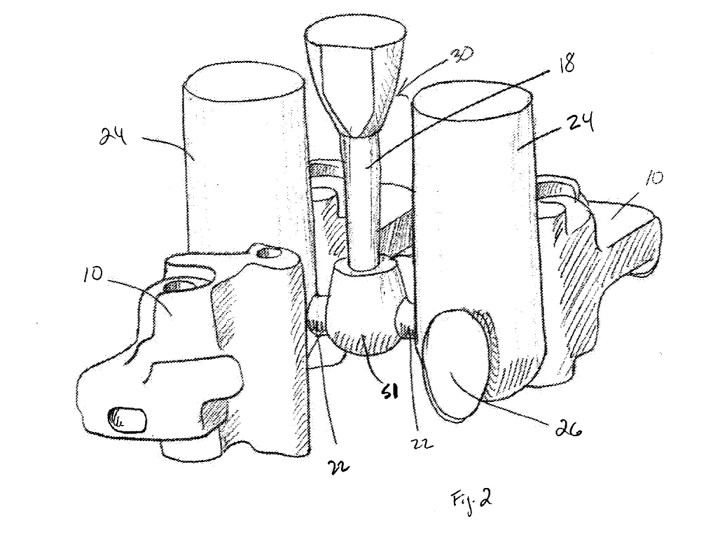

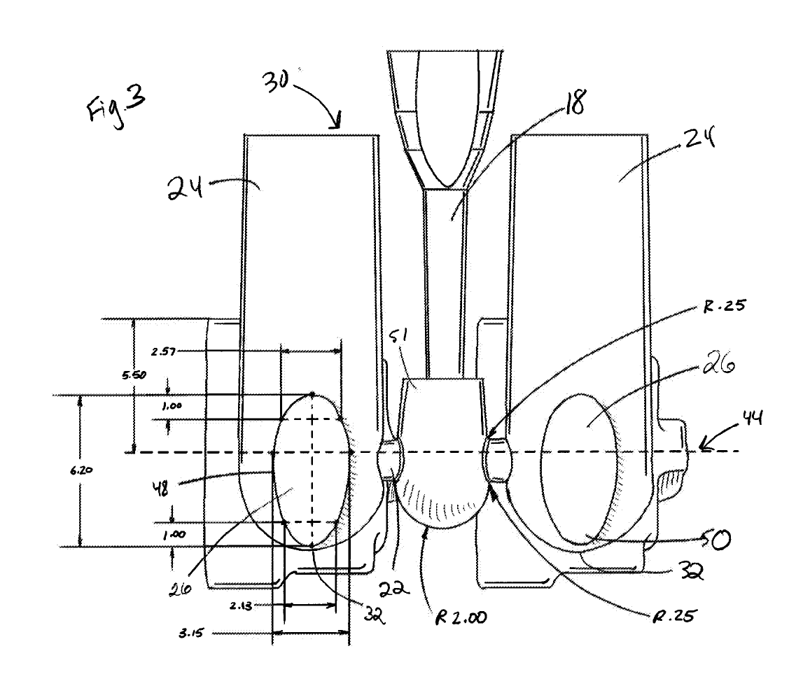

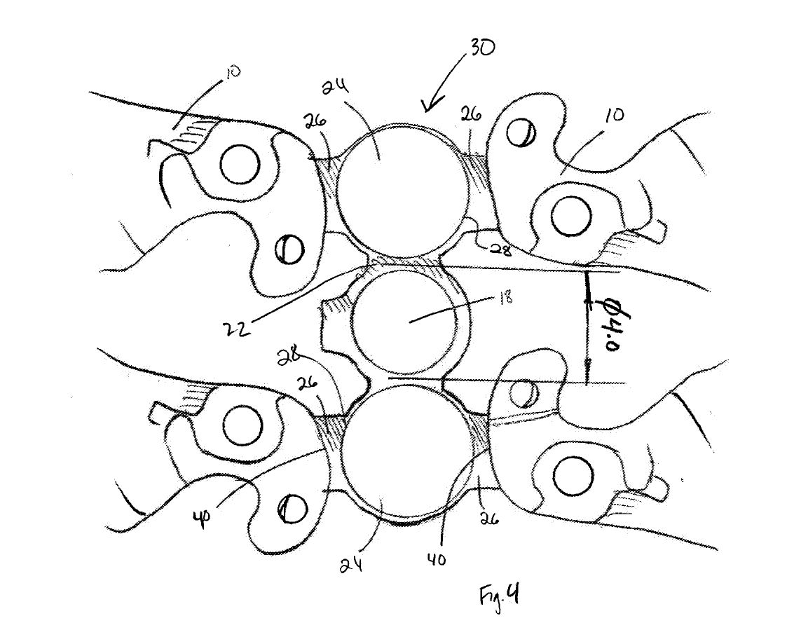

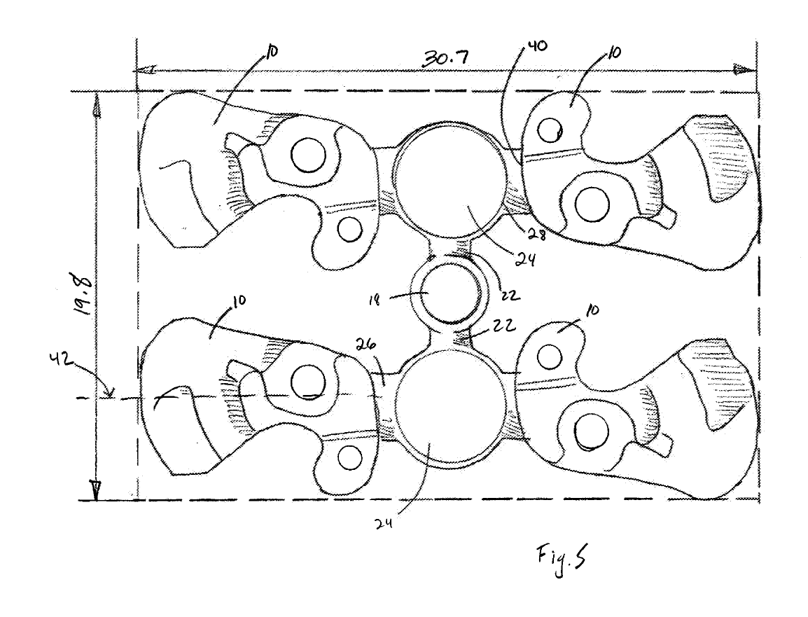

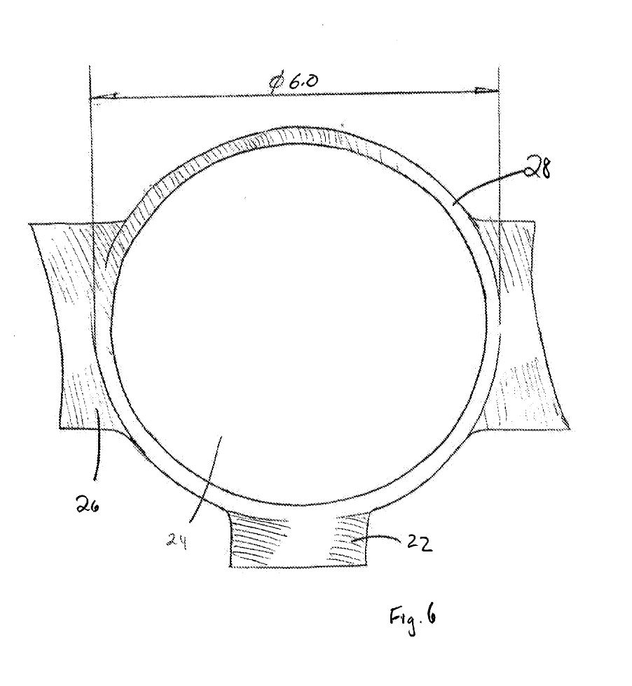

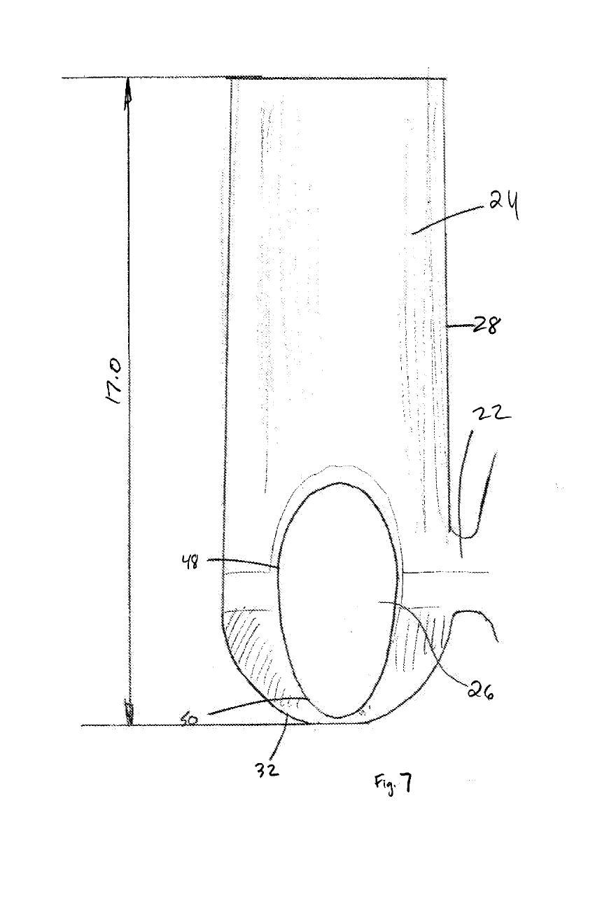

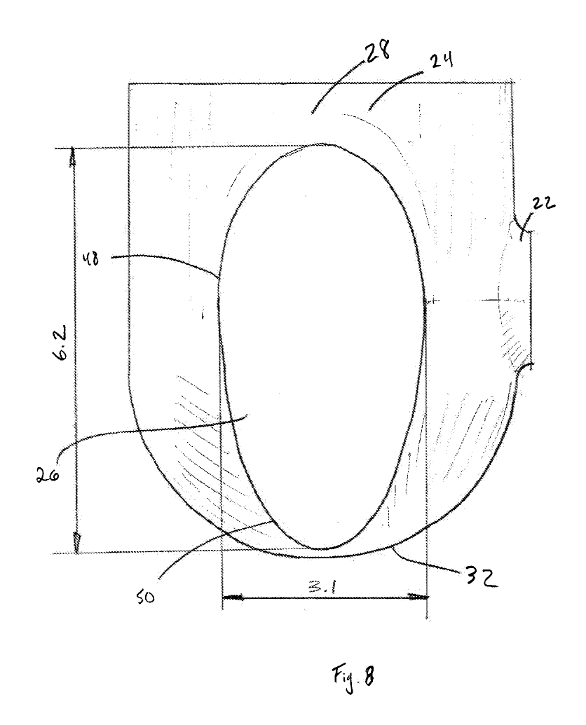

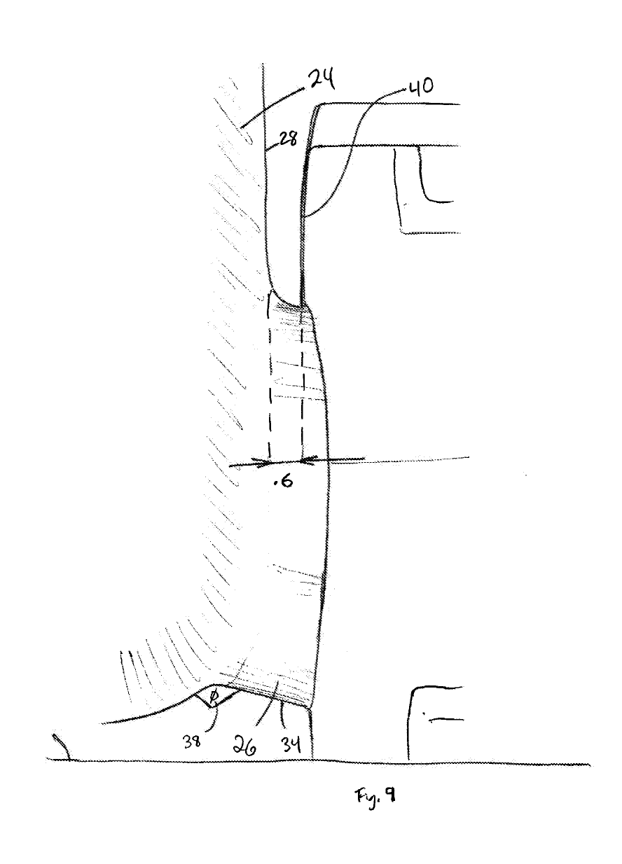

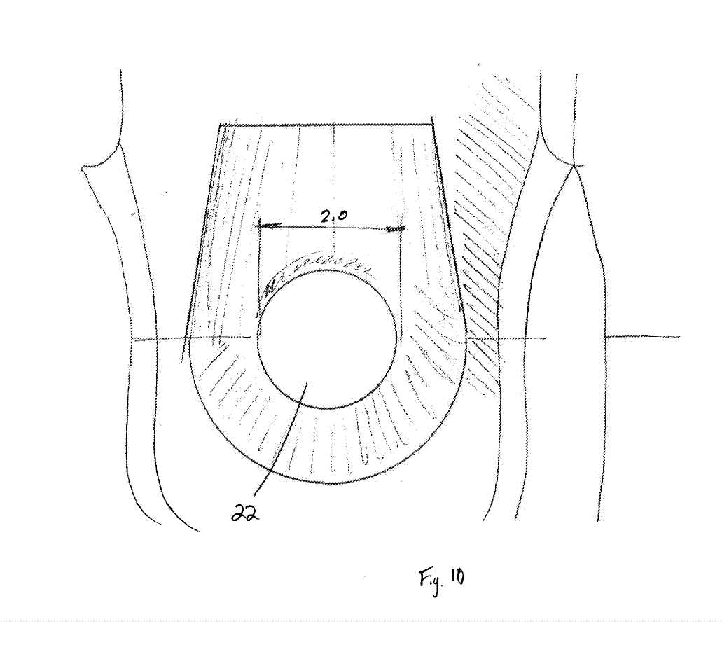

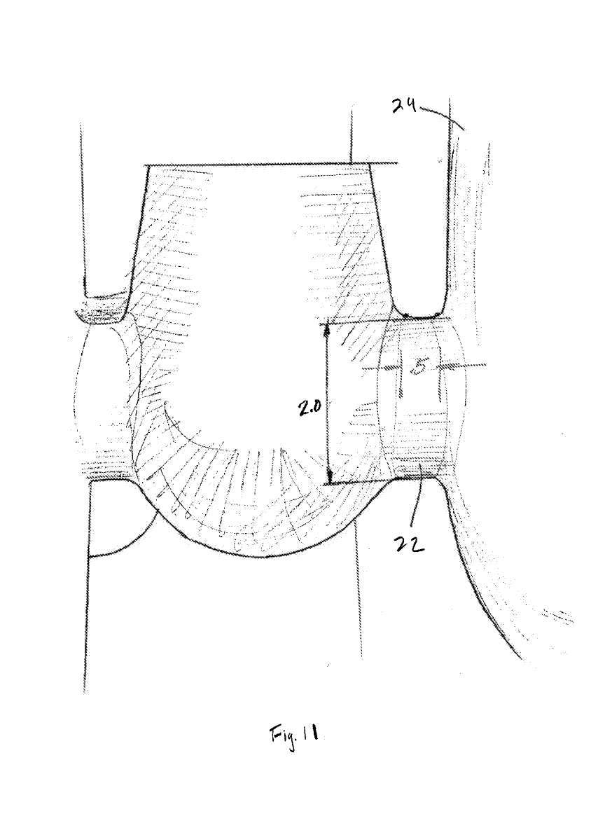

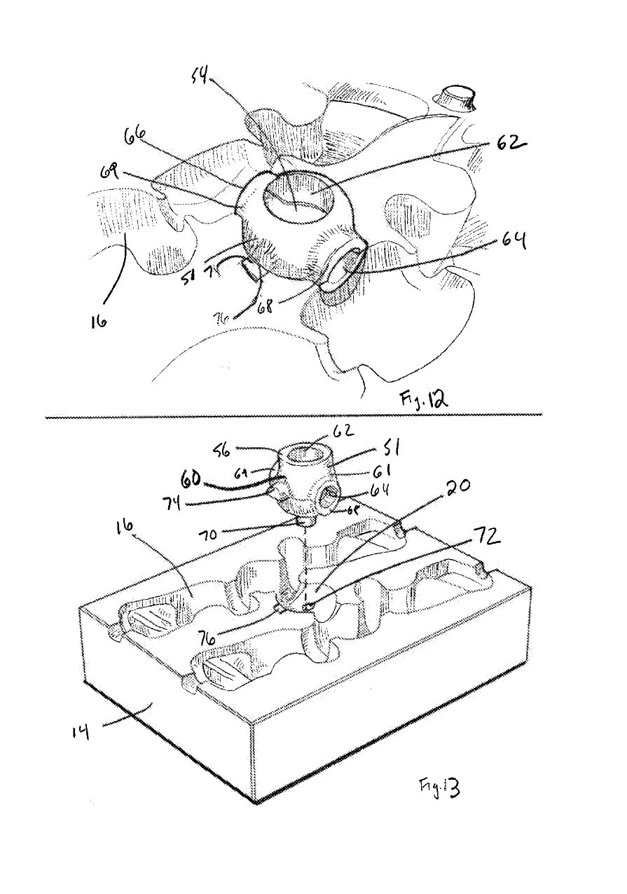

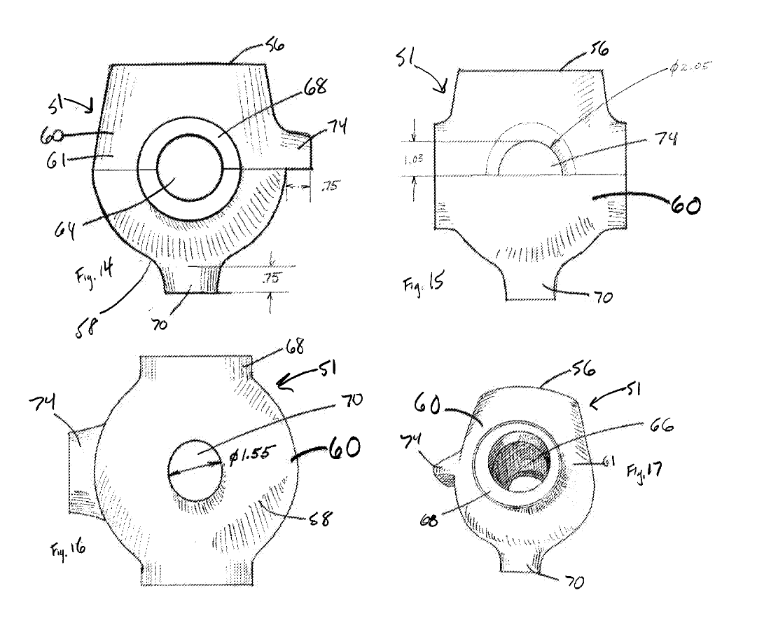

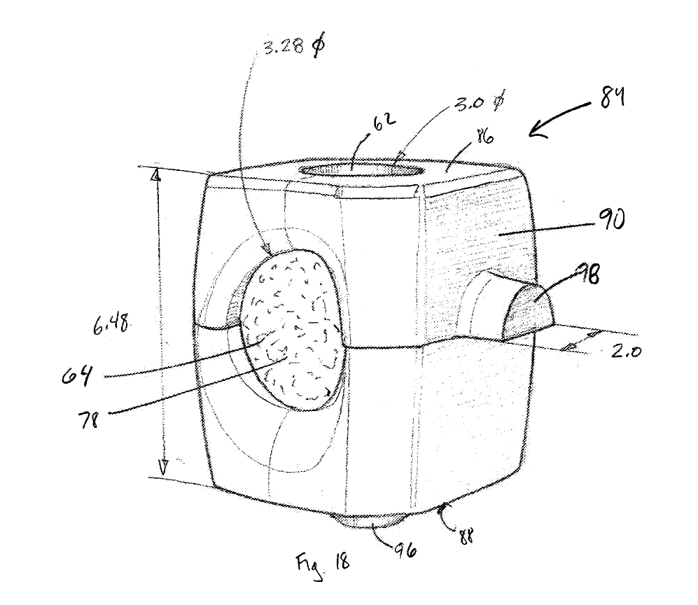

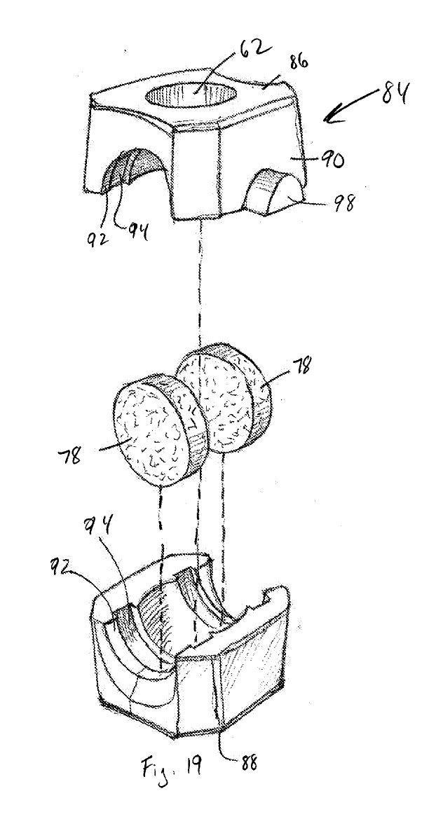

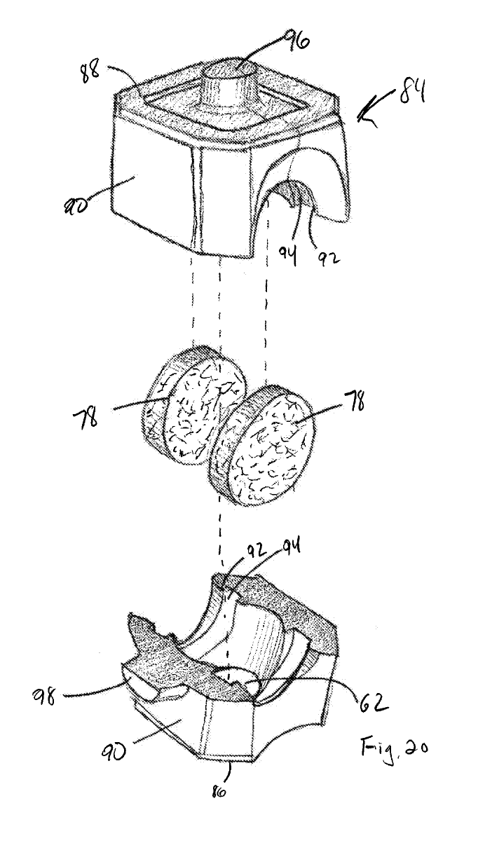

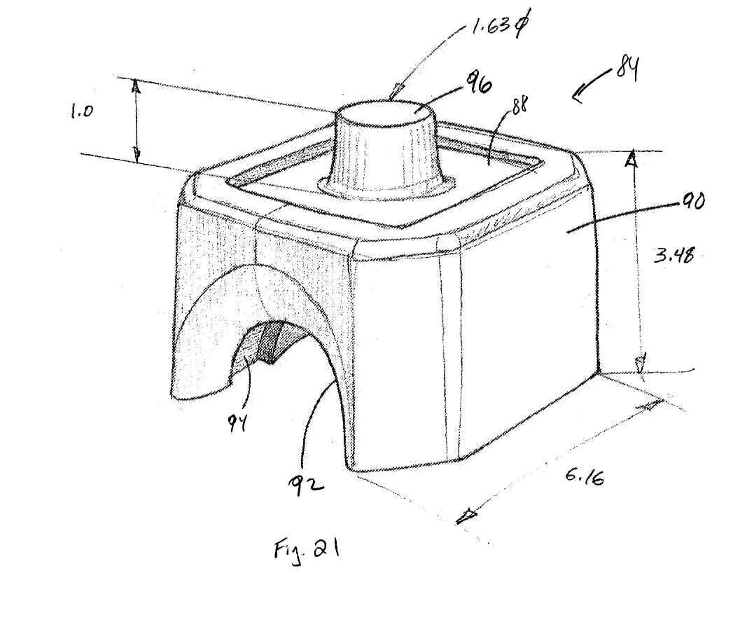

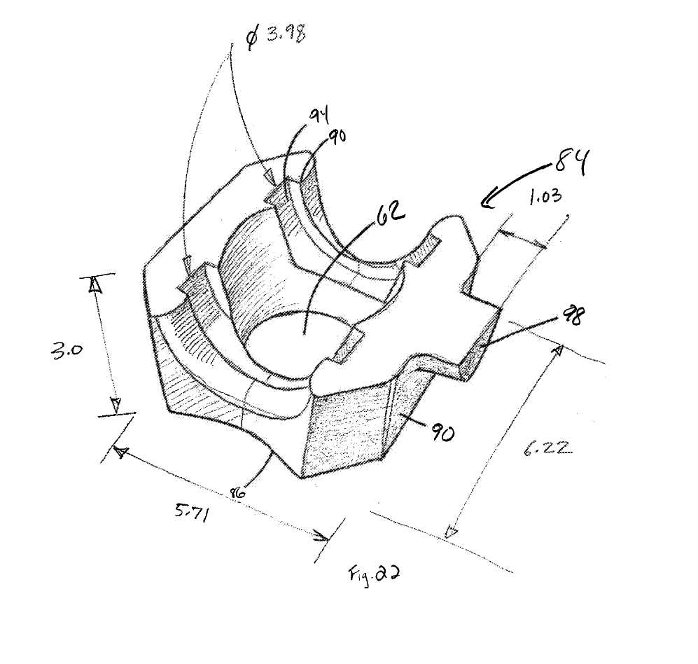

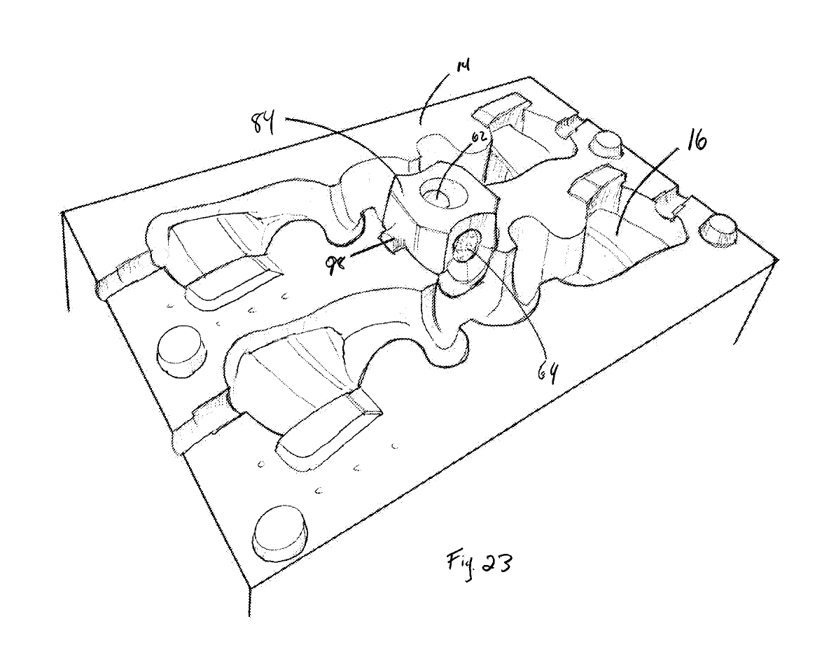

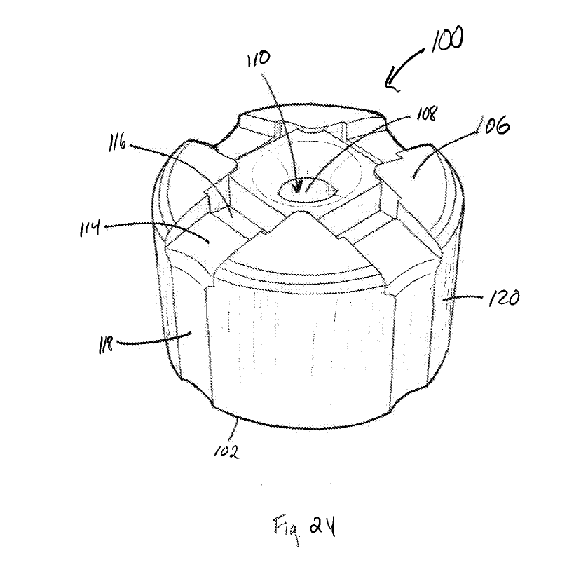

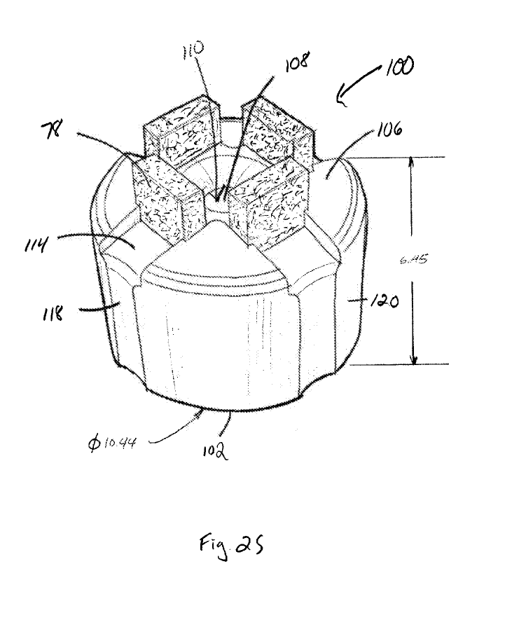

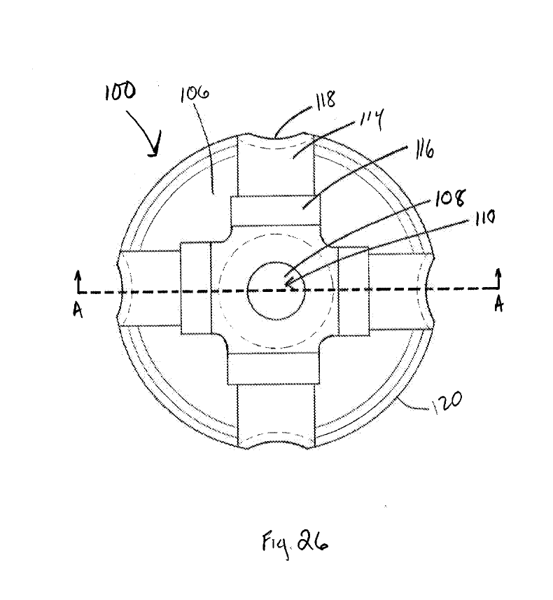

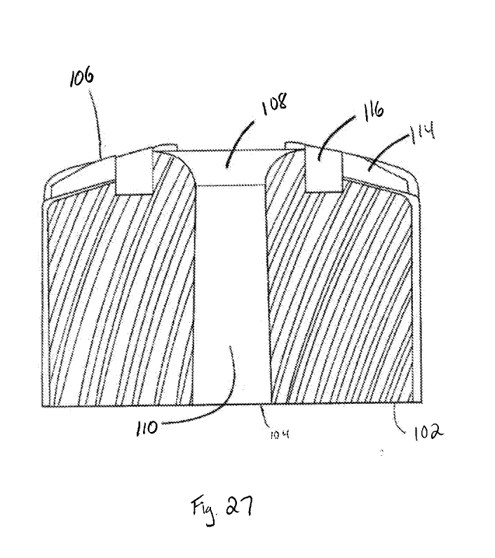

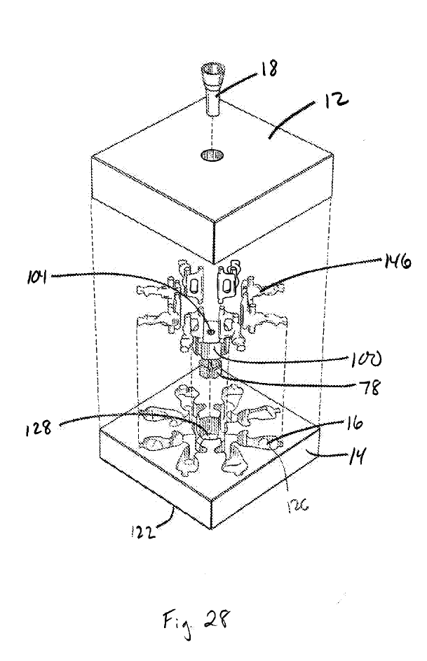

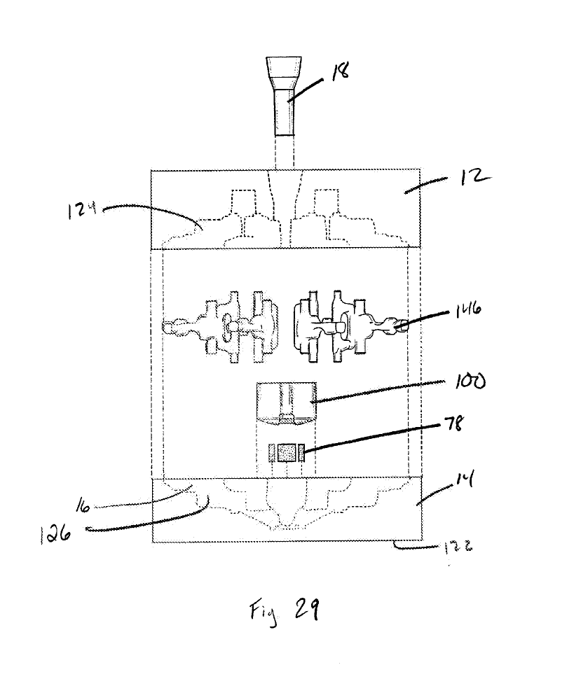

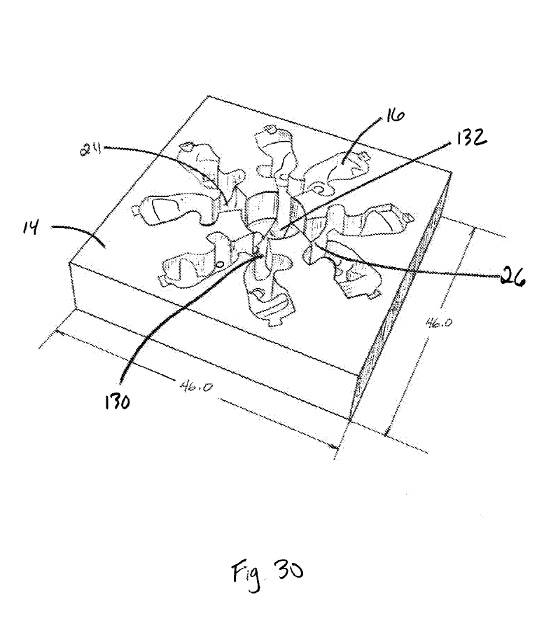

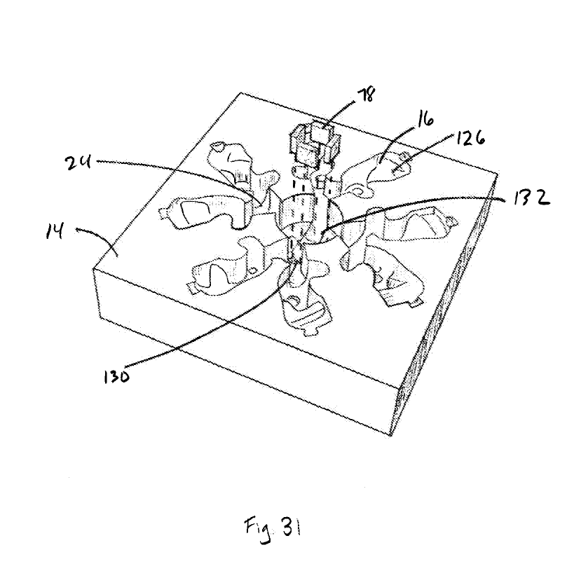

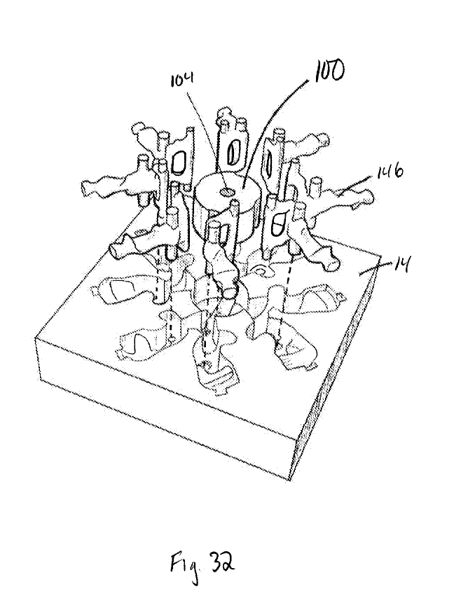

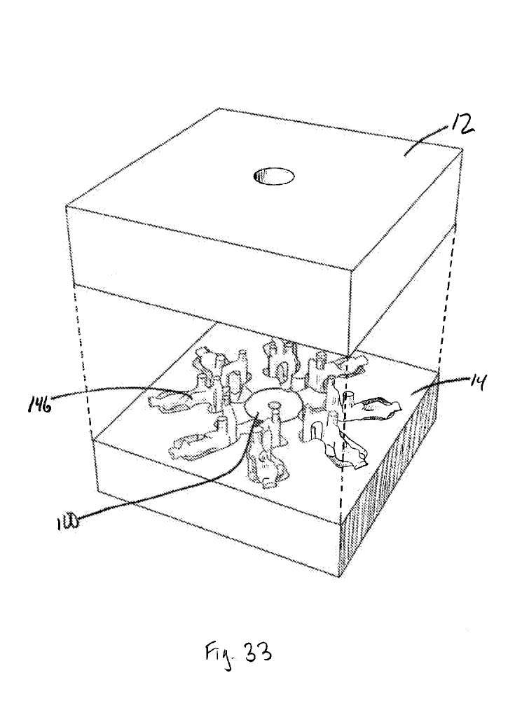

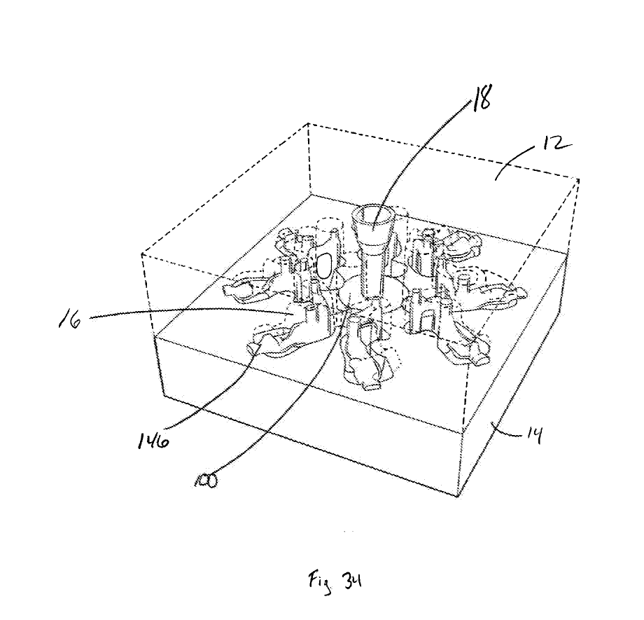

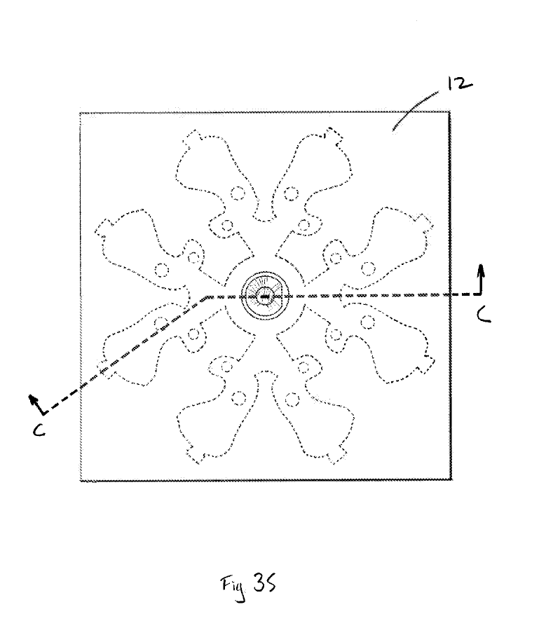

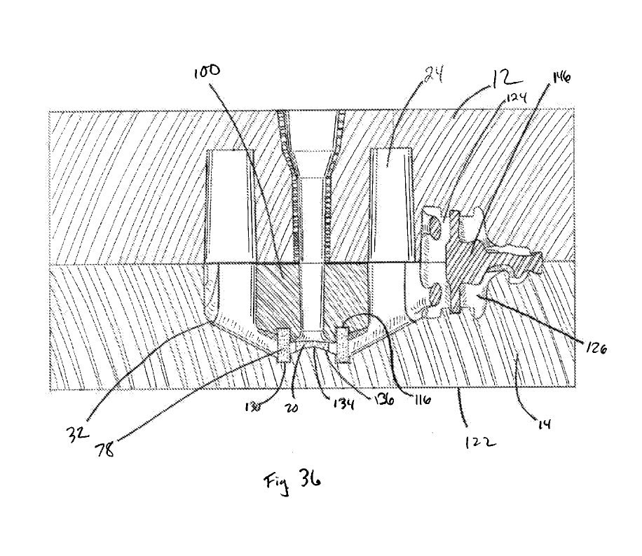

FIG. 1 shows the four cast knuckles 10 still attached to the rigging 30 after the mold is removed. The rigging results from the excess metal that remains in the down sprue 18, the well 20, the runners 22, the risers 24, the ingates 26 and the vents (not shown). References herein to the down sprue 18, the well 20 (or down sprue core 51), the runners 22, the risers 24 and the ingates 26 are illustrated in the figures as the rigging with the understanding that the actual down sprue 18, well 20, runners 22, risers 24 and ingates 26 are impressions formed in the cope and drag 14 portions of the mold.

In one embodiment, the ingates 26 are designed such that they have a non-circular shape. In the illustrated embodiment, the non-circular shape is a teardrop or generally oval shape with the thinner portion of the teardrop shape on the lower part of the ingate 26, near the bottom 32 of the riser 24. Furthermore, the bottom wall 34 of the ingate 26 slopes downward towards the bottom surface 36 of the drag portion 14 creating an obtuse angle 38 with the side wall 28 of the riser forming a downward slope in the ingate 26 for the molten metal to flow. The downward slope of the ingate 26 into the knuckle cavity 16 allows the metal to enter the knuckle cavity 16 at the front face of the knuckle with less turbulence, thus reducing the amount of entrapped air in the cavity that can lead to precipitation of non-metal inclusions.

The teardrop shape and downward sloping bottom wall 34 of the ingate 26 create advantages over traditional ingates. The thinner bottom portion of the teardrop shape reduces turbulence of the molten metal as it flows through the ingate 26 into the knuckle cavity 16. Additionally, the downward sloping bottom wall 34 of the ingate allows the knuckle cavity 16 to fill from the bottom rather than spilling into the knuckle cavity 16 from a higher point on the front face 40. The front face 40 feeding position aids in uniform metal solidification since the knuckle has a more symmetrical shape along line 42 as shown in the figures than along any other axis of the knuckle.

The dimensions of the risers 24 and ingates 26 have been increased over traditional methods to provide better metal flow. The down sprue 18 preferably has an internal diameter of at least 1.4″ and a cross-sectional area of at least about 1.5 square inches. The well 20 is preferably at least about 5″ tall and 4″ wide. The risers 24 are preferably at least about 12″ high from the curved bottom wall 32 to the top wall 33 of the riser 24. In one embodiment, the risers have a volume of at least about 300 cubic inches. The risers 24 preferably have a cross-sectional area of at least 25 square inches. The runners 22 are preferably less than about 2″ long measured from the side wall 45 of the well 20 to the side wall 28 of the attached riser 24. The runners 22 preferably have a cross sectional area of at least 3 square inches. An imaginary axis 44 drawn horizontally through the runner 22 divides the knuckle cavity 16 such that approximately half of the vertical height of the knuckle cavity 16 (and resulting knuckle 10) is above this axis 44 and approximately half of the vertical height of the knuckle cavity 16 is below this axis. Additionally, runners 22 can be located completely in the cope 12. In one embodiment, the distance from this axis 44 to the top wall 46 of the knuckle cavity in the cope portion is about 6″.

In the first illustrated embodiment, ingates 26 are teardrop shaped. They measure about 3.15″ wide at the widest cross-sectional portion and about 6″ high, and have a cross sectional area of approximately 15 square inches. The ingates 26 preferably extend about 0.6″ from the side wall 28 of the riser 24 to the front face wall 40 of the knuckle cavity 16.

The illustrated embodiment is substantially compact, with an entire set of rigging for four knuckles, as shown in FIG. 5, having a length of less than about 38″ and a width of less than about 51″. Furthermore, this rigging design is very efficient, having a final sand-to-metal ratio of a finished casting of less than 2.5:1. This sand-to-metal ratio is the weight of the sand divided by the weight of the casting and rigging. This embodiment can also be expanded to be used to cast more or less than four knuckles at once by adjusting the number and positioning of the runners, risers and ingates.

In an additional embodiment, a down sprue core 51, as shown in FIGS. 12-17 is used in the casting process. The down sprue core 51 fits in the well 20 in the drag portion 14 of the mold and replaces the well 20 in the metal flow path. The down sprue core 51 is designed to reduce or eliminate erosion of the sand that makes up the well 20. The down sprue core 51 is preferably formed from finer grain size sand such as sand with an American Foundrymen Society (“AFS”) grain fineness of 75-80. This finer grain size sand has a higher density than the molding sand wall, which is typically AFS grain size 60. The down sprue core 51 can also be a no-bake blown core, which provides a better overall surface as well. The higher density material is less susceptible to erosion by the flowing liquid metal. The down sprue core 51 is designed to feed the risers 24 such that the metal flows into a curved cavity before flowing into the riser 24. The down sprue core 51 protects the actual sand walls of the cope and drag 14 portions of the mold from eroding due to the fast flowing molten metal, which in turn reduces porosity and shrinkage issues within the finished knuckle 10. Moreover, the wash (a refractory coating applied to molds and cores to provide protection against penetration by the molten metal) applied to the removable down sprue core 51 may be applied in a more uniform fashion than baking it onto the sand wall of the well 20. This renders the down sprue core 51 more resistant to penetration and erosion while allowing for high velocity metal flow to continue through the well 20.

The details of an embodiment of the down sprue core 51 are shown in FIGS. 12-17. In one embodiment, the down sprue core 51 has a generally hollow body 54 which serves as the main channel through which molten metal flows during the casting process. In the embodiment shown, the body 54 takes a cone/spherical shape, but it can take any shape desired. The top wall 56 of the down sprue core 51 includes a first opening 62 that substantially matches and aligns with the down sprue 18 defined in the mold. The bottom wall 58 of the illustrated down sprue core 51 is rounded to match the shape of the well 20 defined in the drag portion 14 of the mold but it can take any shape desired. The side wall 60 of the down sprue core 51 is tapered such that the thinnest cross-sectional portion of the down sprue core 51 is at the top wall 56.

In the illustrated embodiment, which shows the down sprue core 51 as part of a four knuckle casting method, the down sprue core 51 includes second 64 and third 66 openings in the side wall 60. These openings 64, 66 are aligned with the risers 24 defined in the cope and drag 14 portions of the mold. The second 64 and third 66 openings feed directly into first 68 and second 69 hollow cylindrical walls or “shoulders” extending from the side wall 60 of the down sprue core 51. These hollow cylindrical walls 68, 69 effectively form the runners 22 that feed into the risers 24. These hollow cylindrical walls 68, 69 also protect the runners 22 defined in the mold from eroding and can extend into the riser 24 cavity. When the down sprue core 51 is seated in the well 20, the hollow cylindrical walls 68, 69 fit into the indentations that would normally form the runners 22. This also helps maintain the proper positioning of the down sprue core 51 in the well 20. When metal is poured through the down sprue core 51, the metal runs through the openings 64, 66 in the down sprue core 51 and through the runner 22 created within the hollow cylindrical walls 68, 69. Again, this prevents sand erosion from the surfaces of the cope 12 and drag 14 that would typically form the runners 22.

In one embodiment, the second 64 and third 66 openings are between about 2.25″ and 3.75″ in diameter and the first 68 and second 69 hollow cylindrical walls extend between about 0.5″ to 1.5″ from the side wall 60 of the down sprue core 51. The hollow cylindrical walls 68, 69 may also be between about 0.25″- and 0.75″ thick. The openings in the first 68 and second 69 hollow cylindrical walls have an inside diameter that is substantially the same as the second 64 and third 66 openings in the side wall 60 of the down sprue core 51, or about 2″.

The down sprue core 51 can also include filters 78 to aid in filtering out impurities in the metal and to reduce turbulence in the metal by controlling the metal flow. In one embodiment, the filters 78 are ceramic filters. In one embodiment, channels 80 are provided in the interior surface 82 of the side wall 60 of the down sprue core 51. In the illustrated embodiment, the channels 80 are arcuate to match the circular filters 78, but they can take any shape to accommodate any size or shape of filter 78 such as square in the case of a square filter. The filters are positioned such that in order to flow out of the second 64 and third 66 openings and into the runners 22, the metal must pass through the filters 78.

Furthermore, the down sprue core 51 can be a two piece core. This is especially helpful if filters 78 are used, as it allows the core 51 to be split in half to allow installation of the filters 78.

In practice, when metal is poured into the down sprue 18, it flows into the hollow interior 54 of the down sprue core 51, out through the second 64 and third 66 openings through the openings in the first 68 and second 69 hollow cylindrical walls into the risers 24, and out through the ingates 26 into the knuckle cavities 16.

The down sprue core 51 also includes multiple alignment features that prevent the down sprue core 51 from being positioned incorrectly in the drag portion 14 of the mold. The first alignment feature is a first extension 70 defined on the outside surface of the outer wall of the bottom 58 of the down sprue core 51. This extension is preferably cylindrical but can take any shape desired. The first extension 70 matches an opening 72 defined in the drag portion 14 of the mold and helps set the height of the down sprue core 51. In one embodiment, the first extension 70 extends about 1″ from the bottom wall 58 of the core 51 and has a radius of between about 0.5″ and 1.5″. In another embodiment, the first extension 70 has a diameter of about 2″.

The second alignment feature is preferably a second extension 74 defined on the side wall 60 of the down sprue core 51 between the second 64 and third 66 openings that feed the risers 24. The second extension 74 is preferably a cylindrical trough that is shaped to match an opening 76 defined in the drag portion 14 of the mold. In one embodiment, the second extension 74 has a radius of between 0.5″ and 1.5″ and extends about 2″ from the side wall 60. The second extension 74 prevents the down sprue core 51 from being positioned in a reverse position and makes sure that the second 64 and third 66 openings are properly aligned with the openings to the risers 24.

In yet an additional embodiment of the down sprue core 51, the core 51 can include additional openings so that it can feed into four risers 24 which in turn can feed into eight knuckle cavities 16. Additional openings can be added to accommodate feeding additional risers if necessary.

An alternative embodiment of a down sprue core 84 is shown in FIGS. 18-23. In this embodiment, the core 84 includes a top wall 86, a bottom wall 88, and side walls 90. The top wall 86 includes a first opening 62 and at least one of the side walls 90 includes a second opening 64. As is the case with the initially described embodiment, the openings may also have hollow cylindrical walls (not shown) surrounding them. There may also be any number of openings in the side wall 90, depending on how many runners 22 or other portions of the mold are being fed by the core 84.

The interior of this core 84 is shown in FIGS. 19-22. If a filter 78 is used, the internal wall 92 of the core 84 includes at least one channel 94 shaped to match the shape of the filter 78. In the illustrated embodiment the channel 94 is arcuate to match a circular filter 78.

This embodiment may also include a first extension 96 defined on the bottom wall 88 to align it in place in the well 20 and a second extension 98 defined on the outside of the side wall to align the core 84 in place and prevent rotation.

In any of the core embodiments, the first and second extensions may be eliminated and the hollow cylindrical walls may be used to properly position the core in the mold. FIG. 23 shows this core 84 in place in the well 20 of the drag 14.

An additional embodiment of a down sprue core 100 is shown in FIGS. 24-27. In this embodiment, the down sprue core 100 includes a top wall 102 with a first opening 104 defined therein and a bottom wall 106 with a second opening 108 defined therein. The first 104 and second 108 openings are connected by a channel 110 running through the body 112 of the down sprue core 100. This embodiment includes channels 114 defined on the outside surface of the bottom wall 106. These channels 114 form a portion of a runner, which will be explained later with respect to a rigging system utilizing this embodiment of the down sprue core 100. The down sprue core 100 also includes filter seats 116 defined on the bottom wall 78 and connected to the channels 114. These filter seats 116 hold the filters 78 in place when the down sprue core 100 is in place in the mold. They also align with filter seats defined in the mold, which will be described later.

This additional embodiment of the down sprue core 100 may also include channels 118 defined on the side wall 120 of the body 112 of the down sprue core 100. These channels 118 are preferably shaped to form at least part of a side wall 28 of a riser 24, which will be described later.

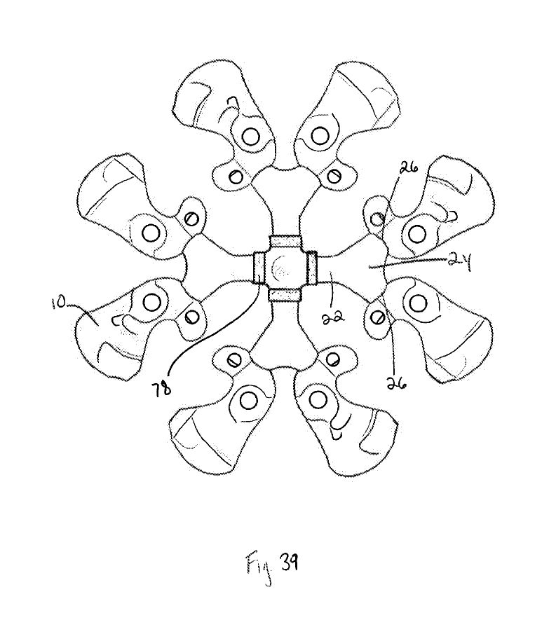

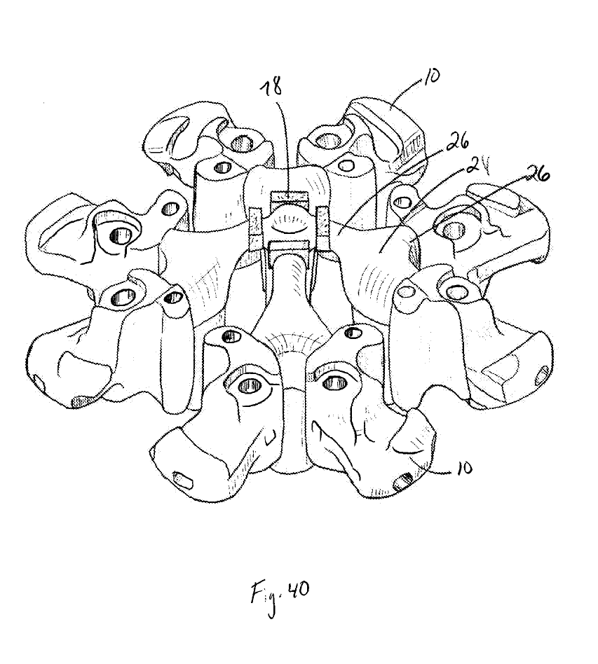

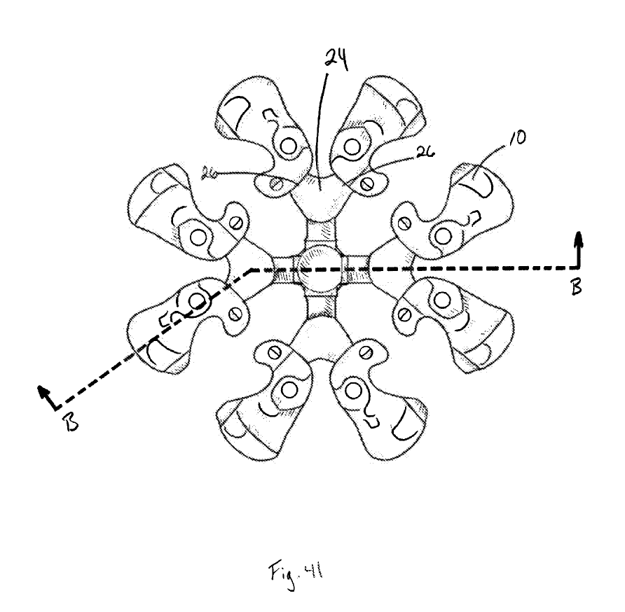

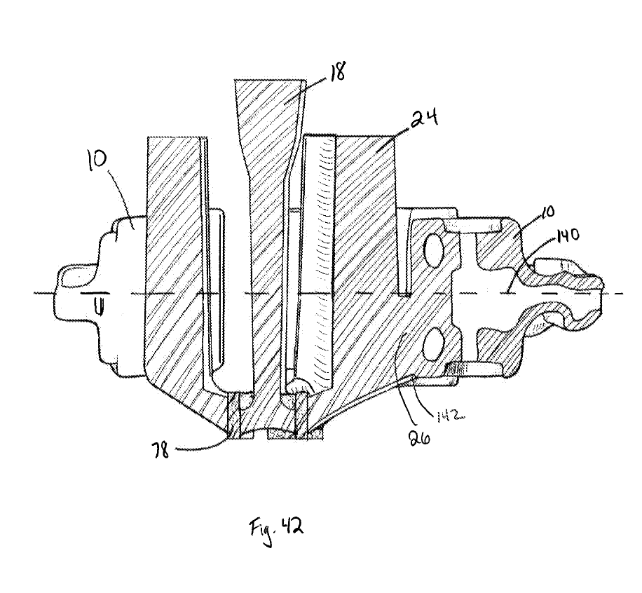

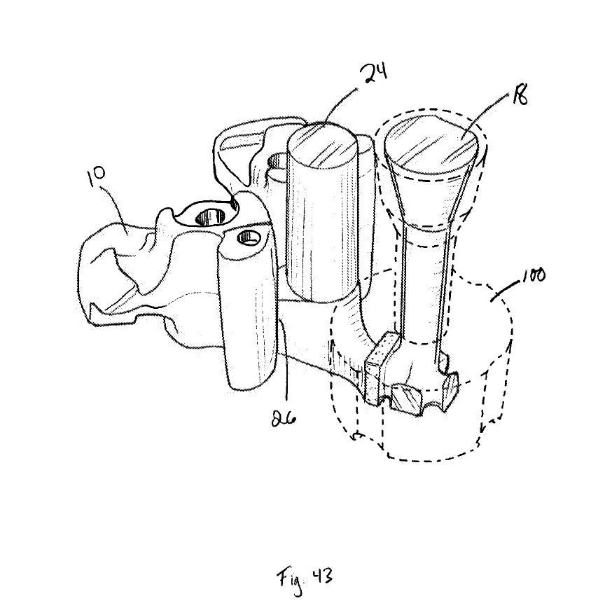

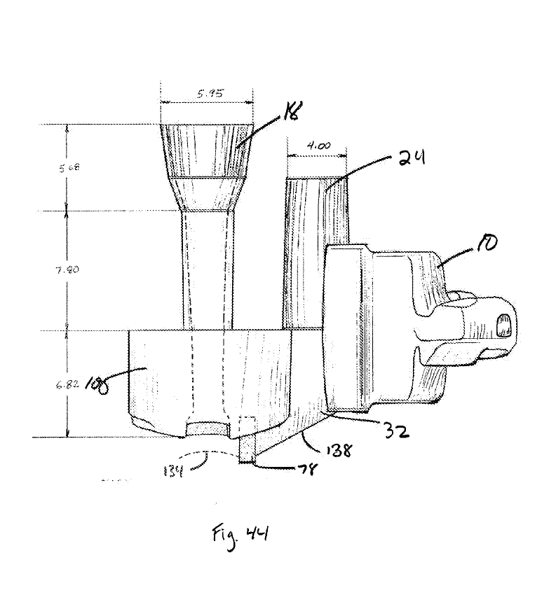

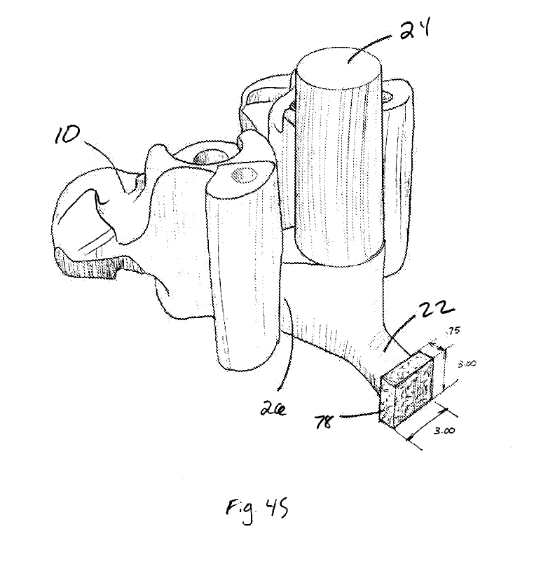

In an additional embodiment of a rigging system the down sprue core 100 described in the previous paragraphs may be used. This rigging system and the corresponding down sprue core 100 are shown in FIGS. 28-45. Beginning with FIG. 35, the rigging system includes cope 12 and drag 14 portions of a mold, and the drag 14 has an outside bottom wall 122. A down sprue 18 is defined in the cope 12 of the mold, but can also extend into the drag 14 of the mold if desired.

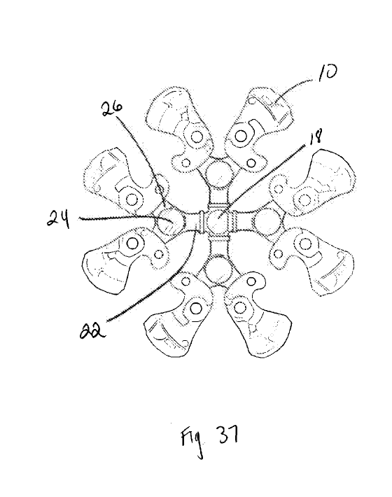

At least one riser 24 is defined in the mold, preferably partially in the cope 12 and partially in the drag 14 portions, and the illustrated embodiment actually includes four risers (although only 2 can be seen in FIG. 36). At least one knuckle cavity 16 is comprised of a first half 124 of the cavity 16 defined in the cope 12 and a second half 126 of the cavity 16 defined in the drag 14. As shown in the other figures, this embodiment actually includes eight knuckle cavities 16, although only one is visible in FIG. 36.

In the illustrated embodiment, the drag 14 includes a core seat 128 that is shaped to match the down sprue core 100 described above. The drag 14 also includes filter seats 130 that match the filter seats 116 defined on the bottom wall 106 of the down sprue core 100. Furthermore, the drag portion includes runners 22 that match the channels 114 defined in the bottom wall 106 of the down sprue core 100. The channel 114 defined in the down sprue core 100 effectively forms the top half of the runner 22 and the runner portion 132 defined in the drag 14 forms the bottom half of the runner 22. Additionally, the drag 14 may include a small well 20 with a curved wall 134 at the base of the well 20 to further improve metal flow. The bottom wall 136 of the well 20 is located closer to the bottom outside wall 122 of the drag 14 than the bottom wall of the riser 24. In other words, the distance from the bottom wall 136 of the well to the bottom outside wall 122 is less than the distance from the bottom wall 32 of the riser 24 to the bottom outside wall 122.

The bottom wall 138 of the runner 22 is also located closer to the outside bottom wall 122 of the drag 14 than the bottom wall 136 of either the well 20 or the riser 24. This can also be described as the bottom wall 138 of the runner 22 being lower in the drag 14 than the well 20 or the bottom 32 of the riser 24. This allows metal to flow upwards towards the riser 24 and with respect to the knuckle cavity 16, which is also located further away from the outside bottom wall 122 (or higher in the drag 14) of the drag 14 than the bottom wall 138 of the runner 22. The runner is preferably non-circular in cross-section as shown in the figures, but can take any shape desired. If a different shape is used for the runner 22, the channel 114 in the bottom wall 106 of the core 100 is adjusted accordingly, as is the bottom portion 132 of the runner 22 defined in the drag 14.

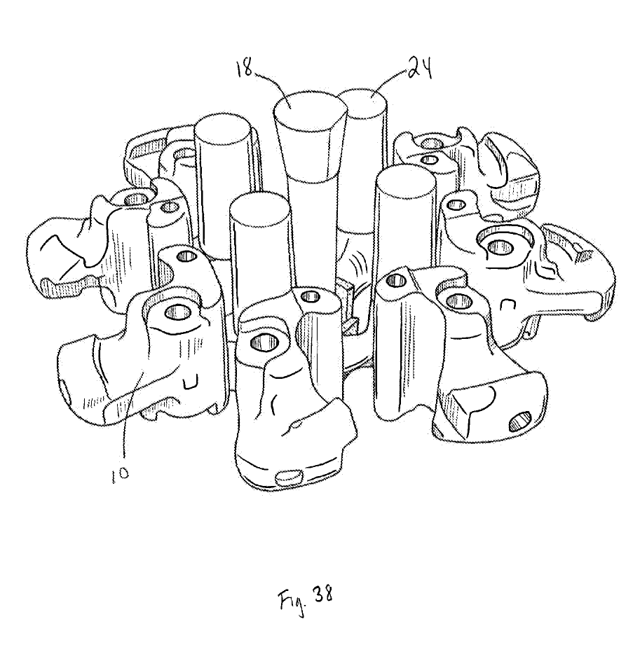

As best seen in top, bottom and perspective views such as FIGS. 37, 39-41 and 43, ingates 26 extend from the riser 24 and connect to the knuckle cavity 16. Again, there can be any number of ingates 26 feeding any number of knuckle cavities 16 from any number of risers 24. The illustrated embodiment shows a very efficient rigging system that is capable of molding eight knuckles 10 at one time in a mold that is less than or equal to about 38″ wide and less than or equal to about 51″ long. In the illustrated embodiment, four runners 22 feed four risers 24. Each riser 24 has two ingates 26 each feeding one knuckle cavity 16 for a total of eight knuckle cavities 16 and eight cast knuckles 10 when the process is complete.

The ingates 26 of this embodiment are also specially designed. For example, in the cross-sectional views such as FIGS. 36, 42 and 44 the ingates 26 are positioned such that they are substantially below the horizontal line of symmetry 140 of the knuckle cavity 16. In one embodiment, the bottom wall 142 of the ingates enters the knuckle cavity 26 within about 5″ of the bottom wall 144 of the knuckle cavity 16. In yet another embodiment, the ingate 26 is positioned within 2″ of the bottom wall 32 of the riser 24.

The assembly and use of an embodiment of the rigging system is shown in FIGS. 28-34. FIG. 28 shows the entire system in an exploded view. The cope 12 and drag 14 portions are separated to show their interior. The down sprue 18 is positioned above the cope 12. The interior of the drag 14 can be seen, showing the knuckle cavities 16, core seat 128, well 20, risers 24 and ingates 26. FIG. 29 shows a side view with the rigging portions that are within the cope 12 and drag 16 portions in phantom. In this view, it is easier to see each half 124, 126 of the knuckle cavities 16 as well as the well 20, runners 22, and risers (with portions in both the cope 12 and the drag 14). The knuckle cores 146 used to create the interior spaces of the knuckle 10 are also shown aligned with their final position in the cavities 16 as well as the down sprue core 100 and the filters 78.

FIG. 30 shows the drag 14 without any of the other parts and FIG. 31 shows the filters 78 being positioned in the filter seats 130 of the drag 14. FIG. 32 shows the knuckle cores 146 and down sprue core 100 about to be positioned in the half 126 of the knuckle cavity 16 defined in the drag 14 and the core seat 128 respectively. FIG. 33 shows the knuckle cores 146 and down sprue core 100 in place in the drag 14 and the cope 12 about to be lowered to close the mold. FIG. 34 shows an internal view of the closed cope 12 and drag 14 with the down sprue 18 also in position. FIG. 36 shows a cross-sectional view along line C-C to show the down sprue core 100, filters 78, and knuckle cores 148 in place in the closed cope 12 and drag 14 portions. The well 20, runners 22, risers 24 and one ingate 26 are also shown. In this embodiment, when the core 100 is seated in the core seat 128, the top of the core 100 does not extend above the top wall of the drag 14.

This rigging construction is used in a method for casting railcar coupler knuckles 10. Because of the design and positioning of the rigging, particularly the runners 22 and well 20 being positioned below the knuckle cavities 16, it allows the molten metal to flow upwards into the riser 24 and then upwards again into the knuckle cavity 16, thus entering the knuckle cavity 16 at or near the bottom wall 144 of the knuckle cavity 16, preferably within 5″ of the bottom wall 144 of the knuckle cavity 16. In one embodiment, the metal entering the cavity descends less than 3″ after exiting the ingate 26 and before contacting the bottom wall 144 of the knuckle cavity 16. This reduces turbulence in the metal which in turn can reduce the amount of air that can become entrapped in the metal and reduce the amount of non-metallic inclusions that may occur because of that entrapped air. Finally, the present rigging could be adjusted such that the ingate 26 actually enters the knuckle cavity 16 in the bottom wall 144.

Many variations can be made to the rigging, down sprue core and method of the present application. Any number of parts can be cast using this rigging design, it is only a matter of adding more runners, ingates, risers and cavities to the system. Other parts could also be cast with this rigging by replacing the knuckle cavities with different shaped cavities. The down sprue cores can be used in multiple types of rigging systems, including those not described herein. The dimensions referenced in the text and illustrated in the figures are also exemplary and can be adjusted as needed. Furthermore, any type of appropriate size, shape and material filter can be used in the system. The sizes of the elements shown in the figures are estimates only, and they could be adjusted if necessary to make different sized parts. Additionally, this rigging system could be used with any type of molding sand, including but not limited to green sand and no-bake (or air set) sand. It could also be used with other molding materials if necessary.

Therefore, it is intended that the foregoing detailed description be regarded as illustrative rather than limiting, and that it be understood that it is the following claims, including all equivalents, that are intended to define the spirit and scope of this invention.

1.-53. (canceled)

54. A core for use in railcar coupler part casting processes, said core comprising:
a body with a side wall;
a first opening in a top wall of said body;
a second opening in a bottom wall of said body;
a channel defined through said body connecting said first and said second openings; and
at least one channel defined in said bottom wall.

55. The core of claim 54, further comprising at least one filter seat defined in said bottom wall.

56. The core of claim 55, wherein said at least one channel is shaped to match a runner defined in a drag section of a mold.

57. The core of claim 56 wherein said filter seat is connected to said at least one channel.

58. The core of claim 57, further comprising a plurality of channels defined in said bottom wall of said core.

59. The core of claim 58, further comprising a plurality of filter seats defined in said bottom wall of said core.

60. The core of claim 54, further comprising at least one channel defined in said side wall of said core.

61. The core of claim 60, wherein said at least one channel defined in said side wall is connected to said at least channel defined in said bottom wall.

62. The core of claim 61, wherein said at least one channel defined in said side wall is shaped to form a portion of a vertical wall of a riser defined in a mold.

63. The core of claim 62, further comprising at least one filter seat defined in said bottom wall.

64. The core of claim 63, wherein said at least one channel is shaped to match a runner defined in a mold.

65. The core of claim 64, wherein said filter seat is connected to said at least one channel.

66. The core of claim 65, further comprising a plurality of channels defined in said bottom wall of said core.

67. The core of claim 66, further comprising a plurality of filter seats defined in said bottom wall of said core.

68. The core of claim 67, further comprising a plurality of channels defined in said side wall of said core.

69. The core of claim 68, wherein said core is shaped to match a core seat defined in a mold.

70. The core of claim 69, wherein when said core is in place in said core seat of said mold, said plurality of filter seats defined in said bottom wall of said core are each aligned with one of said plurality of said filter seats defined in said mold and said plurality of channels defined in said bottom wall of said core are each aligned with one of said plurality of channels defined in said drag section of said mold.

71. A core construction for use in casting railcar coupler parts, said core construction comprising:
a core with a body;
a first opening in a top wall of said body;
a second opening in a bottom wall of said body;
a channel defined through said body connecting said first and said second openings;
at least one channel defined in said bottom wall;
at least one filter seat defined in said bottom wall; and
at least one filter positioned in said filter seat.

72. The core construction of claim 71, further comprising a drag section of a mold, said drag section having at least one channel defined therein, said channel substantially matching said at least one channel defined in said bottom wall of said core.

73. The core construction of claim 72 further comprising a core seat defined in said drag section of said mold, said core seat substantially matching the shape of said core.

74. The core construction of claim 73 wherein said drag section further comprises at least one filter seat defined therein, said at least one filter seat aligning with said at least one filter seat defined in said core when said core is seated in said core seat of said drag section.

75. The core construction of claim 74, further comprising at least one channel defined in a side wall of said core, said channel connecting to said at least one channel defined in said bottom wall of said core.

76. The core construction of claim 75, further comprising at least one riser defined in said mold, wherein said at least one channel defined in said side wall of said core forms at least a portion of said riser defined in said mold when said core is seated in said core seat.

77. The core construction of claim 72, further comprising a cope matching said drag.

78. The core construction of claim 77, wherein said cope and drag are air set molds.

79. The core construction of claim 73, wherein when said core is positioned in said core seat, said core does not extend above an upper wall of said drag.

80. The core construction of claim 71, further comprising a drag section of a mold, said drag section having at least one knuckle cavity defined therein, said knuckle cavity having a bottom wall.
